(19) United States
(12) Patent Application Publication
(10) Pub. No.: US 2021/0149249 A1
(43) Pub. Date: May 20, 2021

(54) DISPLAY DEVICE

(71) Applicant: Shenzhen China Star Optoelectronics Semiconductor Display Technology Co., Ltd., Shenzhen, Guangdong (CN)

(72) Inventors: Lixuan CHEN, Shenzhen, Guangdong (CN); Xin ZHANG, Shenzhen, Guangdong (CN)

(21) Appl. No.: 16/627,773

(22) PCT Filed: Dec. 18, 2019
(86) PCT No.: PCT/CN2019/126338

§ 371 Date: Dec. 31, 2019

(30) Foreign Application Priority Data
Nov. 19, 2019 (CN) 201911131956.4

(51) Int. Cl. G02F 1/1335; G02F 1/1343; G02B 5/30

(52) U.S. Cl. CPC G02F 1/133553; G02F 1/134309; G02F 2203/02; G02B 5/3041; G02F 1/133514

(57) ABSTRACT

The disclosure provides a display device, including a liquid crystal cell and at least one reflective dielectric layer. The at least one reflective dielectric layer is configured to increase reflection of projected light emitted into the display device, thereby reducing loss of the projected light, which is emitted from a projection pointer, in the display device.

### CROSS-REFERENCE TO RELATED APPLICATIONS

This application claims to priority of China Patent Application No. 201911131956.4 filed on Nov. 19, 2019 in the National Intellectual Property Administration and entitled “DISPLAY DEVICE”, the disclosure of which is incorporated herein by reference.

### FIELD

The present disclosure relates to the field of display and, more particularly, relates to a display device.

### BACKGROUND

With development of display technology, new-type display devices are continuously rolled out. Conventional display devices not only can be bent, but also have advantages such as high contrast, thin body, and lightweight, but even so, display devices cannot be widely used in education or work as projection devices do. The reason is: light emitted from a projection pointer into a display device is absorbed and reflected by layers in the display device, that is, a large amount of light emitted into the display device is lost. As a result, compared with using projection devices, people need more time to find a projection position when they use display devices.

Consequently, to make display devices can be used in education and work as projection devices do, it is necessary to improve projection effect on a surface of a display device so that people can immediately find a projection position where a projection pointer points.

### SUMMARY

The present disclosure provides a display device to solve a problem that light emitted from a projection pointer may be lost in display devices.

An embodiment of the present disclosure provides a display device, including a liquid crystal cell and at least one reflective dielectric layer. The at least one reflective dielectric layer is configured to increase reflection of projected light emitted into the display device, and the projected light is emitted from a projection pointer.

The display device includes two polarizers respectively attached to two opposite sides of the liquid crystal cell, and the at least one reflective dielectric layer is disposed between at least one of the two polarizers and the liquid crystal cell.

In the display device, each of the two polarizers includes a first polarizer attached to a light exiting side of the liquid crystal cell, and the at least one reflective dielectric layer is disposed between the first polarizer and the light exiting side of the liquid crystal cell.

In the display device, the at least one reflective dielectric layer is disposed in the liquid crystal cell.

In the display device, the liquid crystal cell includes a color filter substrate, the color filter substrate includes a first substrate, a first conductive electrode, and a first alignment layer, a first polarizer is attached to a side of the first substrate, the first conductive electrode is disposed on a side of the first substrate away from the first polarizer, the first alignment layer is disposed on a side of the first conductive electrode away from the first electrode, and the at least one reflective dielectric layer is disposed between the first substrate and the first conductive electrode; and/or

the at least one reflective dielectric layer is disposed between the first conductive electrode and the first alignment layer.

In the display device, the at least one reflective dielectric layer is disposed between the first substrate and the first conductive electrode, and a refractivity of the at least one reflective dielectric layer is greater than a refractivity of the first substrate and a refractivity of the first conductive electrode.

In the display device, a difference between the refractivity of the at least one reflective dielectric layer and the refractivity of the first substrate is greater than or equal to 0.4.

In the display device, the refractivity of the at least one reflective dielectric layer is greater than 2.2.

In the display device, the first conductive electrode is a common electrode of the display device.

In the display device, the first conductive electrode is an indium tin oxide transparent electrode or an indium zinc oxide transparent electrode.

In the display device, the liquid crystal cell includes an array substrate, the array substrate includes a second substrate, a second conductive electrode, and a second alignment layer, a second polarizer is attached to a side of the second substrate, the second conductive electrode is disposed on a side of the second substrate away from the second polarizer, the second alignment layer is disposed on a side of the second conductive layer away from the second substrate, and the at least one reflective dielectric layer is disposed between the second substrate and the second conductive electrode; and/or

the at least one reflective dielectric layer is disposed between the second conductive electrode and the second alignment layer.

In the display device, the second polarizer is attached to a light exiting side of the liquid crystal cell, and the second conductive layer is a patterned metal layer.

In the display device, the patterned metal layer includes a first patterned metal layer and a second patterned metal layer, the first metal layer is configured to form a gate and scan lines of a thin film transistor (TFT), and the second metal layer is configured to form a source/drain layer and data lines of the TFT.

In the display device, the second conductive electrode is a common electrode of the display device.

In the display device, the polarizer includes a first polarizer attached to a light exiting side of the liquid crystal cell, a photoexcitation layer is disposed on a surface of the first polarizer, and the photoexcitation layer is excited by light having a first wavelength and emits light having a second wavelength.

In the display device, a material of the photoexcitation layer is one selected from the group consisting of a fluorescent material, a photoluminescent material, and an up-conversion material.

In the display device, the at least one reflective dielectric layer includes a first reflective dielectric layer and a second reflective dielectric layer which are disposed alternately, the first reflective dielectric layer is disposed near a light exiting side of the display device, and a refractivity of the first reflective dielectric layer is greater than a refractivity of the second reflective dielectric layer.

In the display device, the refractivity of the first reflective dielectric layer is greater than or equal to 1.8, the refractivity of the second reflective dielectric layer is greater than 1 and less than or equal to 1.6, and a difference between the refractivity of the first reflective dielectric layer and the refractivity of the second reflective dielectric layer is greater than or equal to 0.4.

In the display device, the refractivity of the first reflective dielectric layer is equal to 2, and the refractivity of the second reflective dielectric layer is equal to 1.6.

In the display device, thicknesses of the first reflective dielectric layer and the second reflective dielectric layer range from 40 nm to 60 nm.

Regarding the beneficial effects: compared with conventional technology, a display device provided by an embodiment of the present disclosure includes at least one reflective dielectric layer, thereby increasing reflection of projected light emitted into the display device, reducing loss of the projected light in the display device, and improving projection effect of the projected light on the display device.

### DESCRIPTION OF DRAWINGS

FIG. 1A is a schematic structural view showing a first display device provided by an embodiment of the present disclosure.

FIG. 1B is a schematic structural view showing a second display device provided by an embodiment of the present disclosure.

FIG. 1C is a schematic structural view showing a third display device provided by an embodiment of the present disclosure.

FIG. 1D is a schematic structural view showing a fourth display device provided by an embodiment of the present disclosure.

FIG. 1E is a schematic structural view showing a fifth display device provided by an embodiment of the present disclosure.

FIG. 2A is a schematic structural view showing a sixth display device provided by an embodiment of the present disclosure.

FIG. 2B is a schematic view when projected light is projected on a surface of a display device.

FIG. 2C is a schematic structural view showing a seventh display device provided by an embodiment of the present disclosure.

FIG. 3 is a schematic structural view showing an eighth display device provided by an embodiment of the present disclosure.

FIG. 4 is a schematic structural view showing a ninth display device provided by an embodiment of the present disclosure.

### DETAILED DESCRIPTION

Embodiments are described below in detail with reference to accompanying drawings to make objectives, technical solutions, and effects of the present disclosure clearer and more precise. It should be noted that described embodiments are merely used to construct the present disclosure and are not intended to limit the present disclosure.

In conventional display devices, especially in liquid crystal display (LCD) devices, projected light is lost in a display device after the projected light is emitted into the display device by a projected pointer so that people cannot immediately confirm a position on a surface of the display device where the projected pointer points. The present embodiment can solve the above problem.

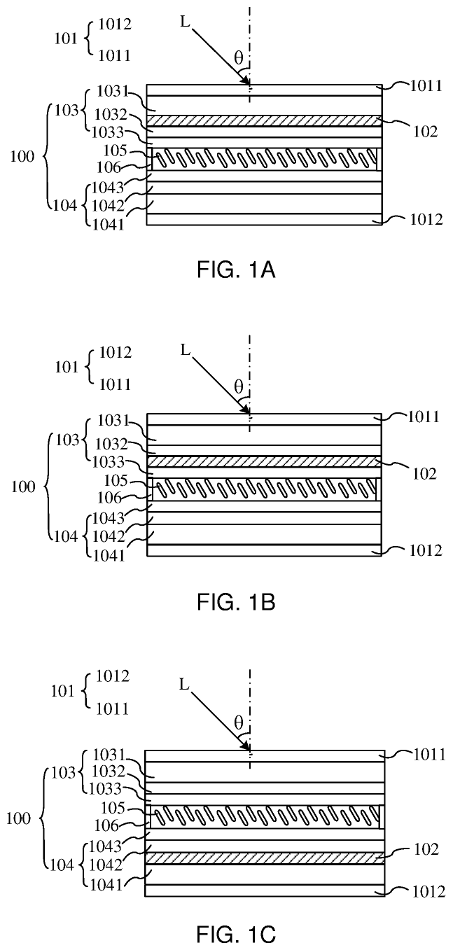

Specifically, refer to FIG. 1A, which is a schematic structural view showing a first display device provided by an embodiment of the present disclosure. The display device includes a liquid crystal cell 100 and at least one reflective dielectric layer 102. The at least one reflective dielectric layer 102 is configured to increase reflection of projected light L emitted into the display device, and the projected light L is emitted from a projection pointer.

The at least one reflective dielectric layer 102 is disposed in the liquid crystal cell 100.

Specifically, the liquid crystal cell 100 includes a color filter substrate 103. The color filter substrate 103 includes a first substrate 1031, a first conductive electrode 1032, and a first alignment layer 1033. A first polarizer 1011 is attached to a side of the first substrate 1031, the first conductive electrode 1032 is disposed on a side of the first substrate 1031 away from the first polarizer 1011, the first alignment layer 1033 is disposed on a side of the first conductive electrode 1032 away from the first electrode 1031, and the at least one reflective dielectric layer 102 is disposed between the first substrate 1031 and the first conductive electrode 1032; and/or

the at least one reflective dielectric layer 102 is disposed between the first conductive electrode 1032 and the first alignment layer 1033.

The liquid crystal cell 100 further includes an array substrate 104, and the array substrate 104 includes a second substrate 1041, a second conductive electrode 1042, and a second alignment layer 1043. A second polarizer 1041 is attached to a side of the second substrate 1012, the second conductive electrode 1042 is disposed on a side of the second substrate 1041 away from the second polarizer 1012, the second alignment layer 1043 is disposed on a side of the second conductive layer 1042 away from the second substrate 1041.

The liquid crystal cell 100 further includes a plurality of liquid crystals 105 and a sealant 106 disposed between the first alignment layer 1033 and the second alignment layer 1043.

Again refer to FIG. 1A, a light exiting side of the display device is disposed near the color filter substrate 103, the at least one reflective dielectric layer 102 is disposed between the first substrate 1031 and the first conductive electrode 1032, and a refractivity of the at least one reflective dielectric layer 102 is greater than a refractivity of the first substrate 1031 and a refractivity of the first conductive electrode 1032. Therefore, an amount of the projected light L emitted into the display device is reduced, and the projected light L reflected by the display device is increased. Specifically, the refractivity of the at least one reflective dielectric layer is greater than 2.2.

Refer to FIG. 1B, which is a schematic structural view showing a second display device provided by an embodiment of the present disclosure, the light exiting side of the display device is disposed near the color filter 103, and the at least one reflective dielectric layer 102 is disposed between the first conductive electrode 1032 and the first alignment layer 1033.

Refer to FIG. 1C and FIG. 1D, it should be noted that the at least one reflective dielectric layer 102 may also be disposed in the liquid crystal cell 100 and on the array substrate 104. That is, the at least one reflective dielectric layer 102 is disposed between the second substrate 1041 and the second conductive electrode 1042, and/or

the at least one reflective dielectric layer 102 is disposed between the second conductive electrode 1042 and the second alignment layer 1043.

Refer to FIG. 1C, which is a schematic structural view showing a third display device provided by an embodiment of the present disclosure, the at least one reflective dielectric layer 102 is disposed between the second substrate 1041 and the second conductive electrode 1042.

Refer to FIG. 1D, which is a schematic structural view showing a fourth display device provided by an embodiment of the present disclosure, the at least one reflective dielectric layer 102 is disposed between the second conductive electrode 1042 and the second alignment layer 1043.

The first conductive electrode 1032 is an indium tin oxide (ITO) transparent electrode or an indium zinc oxide (IZO) transparent electrode. Specifically, the first conductive electrode 1032 is disposed near the liquid crystals 105, and the first conductive electrode 1032 is a common electrode of the display device. The second conductive electrode 1042 is an ITO transparent electrode, an IZO transparent electrode, or a patterned metal layer. Specifically, the second conductive electrode 1042 is disposed near the liquid crystals 105, the second conductive electrode 1042 is a pixel electrode, and the pixel electrode is an ITO transparent electrode or an IZO transparent electrode. The second conductive electrode 1042 is disposed near the second substrate 1041 and is a patterned metal layer.

Refer to FIG. 1E, which is a schematic structural view showing a fifth display device provided by an embodiment of the present disclosure, the second polarizer 1012 is attached to a light exiting side of the liquid crystal cell 100, and the second conductive electrode 1042 is a patterned metal layer. That is, the light exiting side of the display device is disposed near the array substrate 104, the second polarizer 1012 is attached to a side of the second substrate 1041 away from the second conductive electrode 1042, and the second conductive electrode 1042 is a patterned metal layer.

The patterned metal layer includes a first patterned metal layer and a second patterned metal layer, the first metal layer is configured to form a gate and scan lines of a thin film transistor (TFT), and the second metal layer is configured to form a source/drain layer and data lines of the TFT. A material of the patterned metal layer includes Al or Mo, and the material of the patterned metal layer may be a composite material if the material of the patterned metal layer includes low conductivity material such as Mo.

When the projected light L is emitted into the display device, the projected light L will be reflected by an interface between the second conductive electrode 1042 and the second alignment layer 1043 because the second conductive electrode 1042 has a relatively high refractivity. As a result, reflection of the projected light L in the display device is increased.

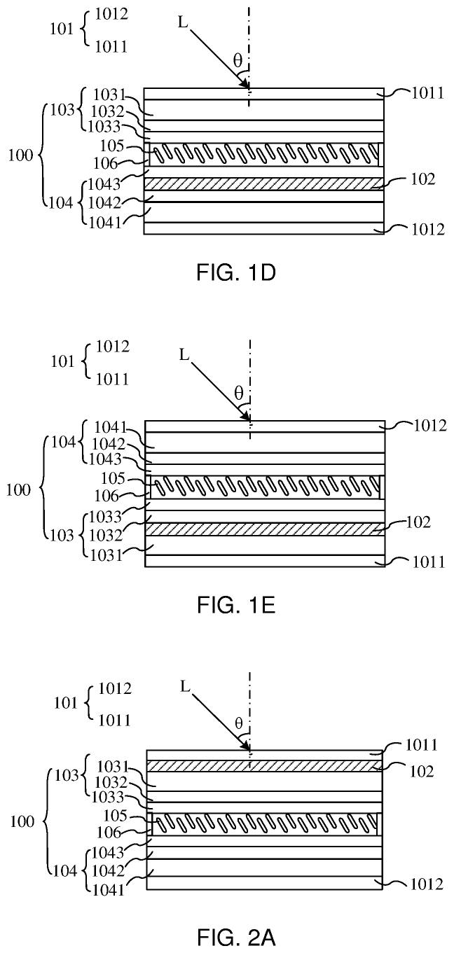

Refer to FIG. 2A, which is a schematic structural view showing a sixth display device provided by an embodiment of the present disclosure, the display device further includes two polarizers respectively attached to two opposite sides of the liquid crystal cell 100, and the at least one reflective dielectric layer 102 is disposed between at least one of the two polarizers and the liquid crystal cell 100.

Specifically, refer to FIG. 2A, each of the two polarizers includes a first polarizer 1011 attached to the light exiting side of the liquid crystal cell 100, and the at least one reflective dielectric layer 102 is disposed between the first polarizer 1011 and the light exiting side of the liquid crystal cell 100. A refractivity of the at least one reflective dielectric layer 102 is greater than a refractivity of the first polarizer 1011 and a refractivity of the first substrate 1031, thereby improving reflection of the projected light L in the display device and improving projection effect of the projected light L on the display device.

Refer to FIG. 2B, which is a schematic when a projected light is projected on a surface of a display device, when the projected light L is projected on the display device, a portion of the projected light L is reflected to air, and another portion of the projected light L is emitted to a surface of the first polarizer 1011 at an incidence angle of θ. Then, an incident light L2 is reflected at an interface between the first polarizer 1011 and the at least one reflective dielectric layer 102, and a reflected light L21 and a refracted light L22 are generated at a surface of the at least one reflective dielectric layer 102. The reflective light L21 is reflected to the first polarizer 1011 and is refracted at an interface between the first polarizer 1011 and air and an interface between the first polarizer 1011 and the at least one reflective dielectric layer 102. The refractive light L22 enters the at least one reflective dielectric layer 102 at an incidence angle of θ2.

Because a refractivity n2 of the at least one reflective dielectric layer 102 is greater than a refractivity n1 of the first polarizer 1011 and a refractivity n3 of the first substrate 1031. Therefore, the at least one reflective dielectric layer 102 is optically denser than the first polarizer 1011 and the first substrate 1031. When the refractive light L22 is emitted from the at least one reflective dielectric layer 102 to a surface of the first substrate 1031, a refraction angle θ3 of the refractive light L22 in the first substrate 1011 is greater than an incidence angle of the refractive light L22 at the surface of the first substrate 1031. A refraction angle θ3 of the refractive light L22 increases to 90° with increase in the incidence angle of the refractive light L22. Meanwhile, the refractive light L22 is fully reflected at an interface between the at least one reflective dielectric layer 102 and the first substrate 1031. When the refraction angle θ3 is 90°, the incidence angle is a critical angle C, wherein C=arcsin(n3/n2).

When a full reflection phenomenon happens, loss of the projected light L in the display device becomes minimum, and reflection of the projected light L becomes maximum. Therefore, when choosing the at least one reflective dielectric layer 102, a full-reflection condition should be tried to be satisfied so that loss of the projected light L in the display device can be reduced. That is, the greater the reflectivity n2 of the at least one reflective dielectric layer 102, the less the reflectivity n3 of the first substrate 1031. Therefore, the critical angle C, which is a condition for which a full-reflection phenomenon occurs in the at least one reflective dielectric layer 102 and the color filter substrate 104, can be reduced, and a full-reflection phenomenon can easily happen.

Because different materials have different reflectivities, reflection angles of the projected light L are different in different layers of the display device. When a full-reflection phenomenon only occurs in the first polarizer 1011 and the at least one reflective dielectric layer 102, reflectivities R of the first polarizer 1011 and the at least one reflective dielectric layer 102 can be obtained by the equation that R=(n0−n2)\hat{ }2/(n0+n2)\hat{ }2, wherein n0 is a refractivity of air.

In actual fact, however, the above display device includes a plurality of stacked layers and the at least one reflective dielectric layer 102. Therefore, the display device can be seen as consisting of multiple dielectric layers having different refractivities. A refractive light L23 may be formed when the projected light L reaches an interface between the at least one reflective dielectric layer 102 and the first substrate 1031, and the refractive light L23 continuously strikes lower layers, generating more refractive and reflective phenomenons. Not only refractive and reflective phenomenons but also an interference effect occurs at interfaces between different layers. Therefore, besides a wavelength λ and an incidence angle of the projected light L, reflection of the projected light L is affected by thicknesses and refractivities of layers in the display device.

As a result, reflectivities of layers in the display device can be obtained by iteration, i.e., two lower interfaces are equivalent to a new interface, the new interface and an interface above the new interface are equivalent to another new interface, and the rest of interfaces can be done in the same manner. Finally, Fresnel coefficient r can be calculated according to law of refraction and Fresnel formula, thereby obtaining a total reflectivity of layers R=|r|\hat{ }2. Reflectivities of layers herein are not limited to the present embodiment, those skilled in the art may obtain the reflectivities of layers by analyzing actual requirements, thicknesses of layers in the display device, refractivity, and a wavelength of the projected light L, and analyzing method of reflectivities of layers are not described here again.

The at least one reflective dielectric layer 102 is disposed near the light exiting side of the display device, thereby reducing refraction and reflection of the projected light L in the display device. Therefore, loss of the projected light L is reduced, the projected light L can be reflected outside the display device in a shorter reflection pace, and projection effect of the projected light L on the display device can be improved.

Furthermore, refer to FIG. 2C, which is a schematic structural device showing a seventh display device provided by an embodiment of the present disclosure. After the projected light L enters the display device, a portion of light is reflected outside the display device by the at least one reflective dielectric layer 102, and another portion of light keeps being transmitted into the display device. As a result, to reflect the light transmitted into the display device and improve reflection of the projected light L, another reflective dielectric layer 102 may be disposed on a backlight side of the display device.

Again refer to FIG. 2C, the light exiting side of the display device is disposed near the color filter substrate 103, the backlight side of the display device is disposed near the array substrate 104, a reflective dielectric layer 1021 is disposed on the color filter substrate 103, and a reflective dielectric layer 1022 is disposed on the array substrate 104. Specifically, the reflective dielectric layer 1021 is disposed between the first substrate 1031 and the first polarizer 1011, and the reflective dielectric layer 1022 is disposed between the second substrate 1041 and the second conductive electrode 1042.

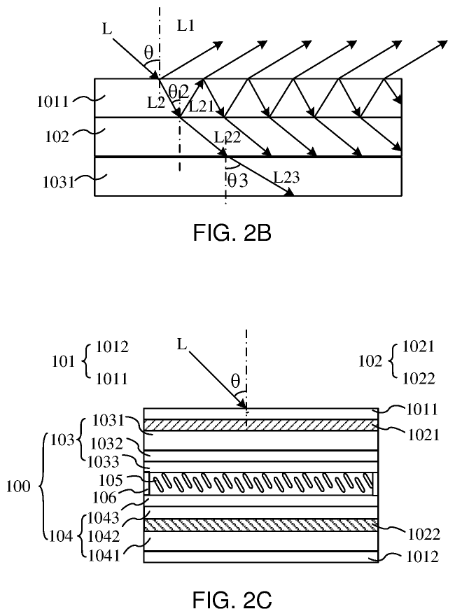

Refer to FIG. 3, which is a schematic structural view showing an eighth display device provided by an embodiment of the present disclosure, the polarizer 101 includes a first polarizer 1011 attached to the light exiting side of the liquid crystal cell 100, a photoexcitation layer 107 is disposed on a surface of the first polarizer 1011, and the photoexcitation layer 107 is excited by light having a first wavelength and emits light having a second wavelength.

A material of the photoexcitation layer 107 is one selected from the group consisting of a fluorescent material, a photoluminescent material, and an up-conversion material. When the photoexcitation layer 107 is made of a fluorescent material, a device that emits the projected light L is a short-wave laser pointer, the photoexcitation layer 107 is excited by the projected light L and emits light having a second wavelength, a wavelength of the projected light L is less than the second wavelength, and the wavelength of the projected light L ranges from 400 nm to 700 nm. When the photoexcitation layer 107 is made of an up-conversion material, the photoexcitation layer 107 is excited by the projected light L and emits light having the second wavelength, the wavelength of the projected light L is greater than the second wavelength, and the wavelength of the projected light L is greater than 900 nm.

If the projected light L enters the display device, the at least one reflective dielectric layer 102 can be disposed in the display device to improve reflection of the projected light L. Specifically, refer to FIG. 3, the reflective dielectric layer 102 is disposed between the at least one first polarizer 1011 and the first substrate 1031.

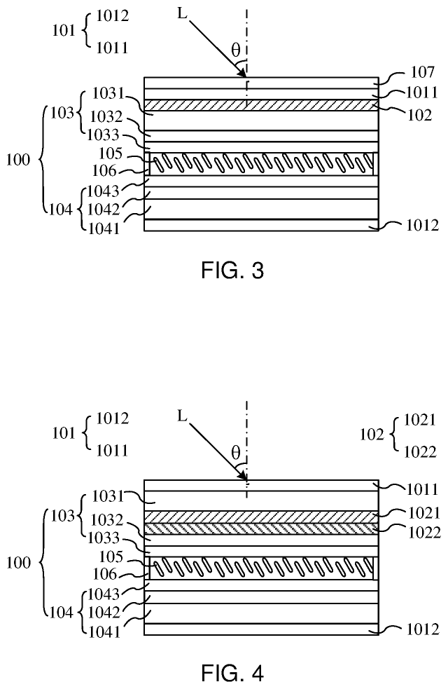

Refer to FIG. 4, which is a schematic structural view showing a ninth display device provided by an embodiment of the present disclosure, the at least one reflective dielectric layer 102 includes a first reflective dielectric layer 1021 and a second reflective dielectric layer 1022 which are disposed alternately, the first reflective dielectric layer 1021 is disposed near the light exiting side of the display device, and a refractivity of the first reflective dielectric layer 1021 is greater than a refractivity of the second reflective dielectric layer 1022.

Specifically, the display device further includes a glass cover plate (not shown). The glass cover plate is attached to a side of the first polarizer 1011 away from the first substrate 1031 by an optically clear transparent adhesive, and a surface of the glass cover plate away from the first polarizer 1011 is the light exiting side of the display device. The at least one reflective dielectric layer 102 is disposed between the first substrate 1031 and the first conductive electrode 1032. The first reflective dielectric layer 1021 is disposed on a side of the first substrate 1031 away from the first polarizer 1011. A side of the second reflective dielectric layer 1022 is in contact with the first reflective dielectric layer 1021, and the other side of the second dielectric layer 1022 is in contact with the first conductive layer 1032. A refractivity of the first reflective dielectric layer 1021 is greater than that of the second reflective dielectric layer 1022.

Specifically, the refractivity of the first reflective dielectric layer 1021 is greater than or equal to 1.8, the refractivity of the second reflective dielectric layer 1022 is greater than 1 and less than or equal to 1.6, and a difference between the refractivity of the first reflective dielectric layer 1021 and the refractivity of the second reflective dielectric layer 1022 is greater than or equal to 0.4.

Furthermore, the refractivity of the first reflective dielectric layer 1021 is greater than 2, the refractivity of the second reflective dielectric layer 1022 is greater than 1 and less than or equal to 1.6, and a difference between the refractivity of the first reflective dielectric layer 1021 and the refractivity of the second reflective dielectric layer 1022 is greater than or equal to 2. Furthermore, the refractivity of the first reflective dielectric layer 1021 is equal to 2, and the refractivity of the second reflective dielectric layer 1022 is equal to 1.6.

Specifically, a material of the first reflective dielectric layer 1021 is SiNx or TiOx, a material of the second reflective dielectric layer 1022 is SiOx, and thicknesses of the first reflective dielectric layer 1021 and the second reflective dielectric layer 1022 range from 40 nm to 60 nm.

The display device may include one reflective dielectric layer 102 as shown in FIG. 1A to FIG. 1E, FIG. 2A, and FIG. 3. Alternatively, the display device may include multiple reflective dielectric layers 102 as shown in FIG. 4.

When the display device includes one reflective dielectric layer 102, to reduce loss of the projected light L in the display device and improve reflection of the projected light L in the display device, the refractivity of the reflective dielectric layer 102 needs to be greater than refractivities of functional layers in the display device adjacent to the reflective dielectric layer 102. The functional layers are layers in the display device except the reflective dielectric layer 102. Specifically, refer to FIG. 1A, the refractivity of the reflective dielectric layer 102 is greater than the refractivities of the first substrate 1031 and the first conductive electrode 1032.

When the display device includes multiple reflective dielectric layers 102, to improve reflection of the projected light L in the display device, a difference between the refractivity of the first reflective dielectric layer 1021 and the refractivity of the second reflective layer 1022 is greater than or equal to 0.4. In addition, differences between the refractivity of the reflective dielectric layer 102 and refractivities of functional layers adjacent to the reflective dielectric layer 102 are greater than or equal to 0.4. The functional layers are layers in the display device except the reflective dielectric layer 102. Specifically, refer to FIG. 4, a difference between the refractivity of the first reflective dielectric layer 1021 and the refractivity of the second reflective dielectric layer 1022 is greater than or equal to 0.4, the refractivity of the first reflective layer 1021 needs to be greater than the refractivity of the first substrate 1031, and a difference between the refractivity of the second reflective layer 1022 and a refractivity of the first alignment layer 1032 needs to be greater than or equal to 0.4.

Because reflectivity of layers may be affected by the refractivity of the reflective dielectric layer 102, a wavelength of the projected light L, and thicknesses of the layers, those skilled in the art may obtain required reflectivity of layers by choosing a material of the reflective dielectric layer 102 and thicknesses of the layers according to the wavelength of the projected light L. The reflective dielectric layer 102 may be disposed in other display devices, such as organic light-emitting diode (OLED) flexible display devices, instead of LCD devices. A disposing way of the reflective dielectric layer 102 in the OLED flexible display devices is similar to that in the LCD devices and is not described here again. Those skilled in the art may obtain other disposing ways of the reflective dielectric layer 102 with reference to the disposing way provided by the above embodiments.

The disposing way of the reflective dielectric layer 102 provided by the present disclosure is only an example and is not described again here. Those skilled in the art may dispose one or more reflective dielectric layers 102 in a display device according to practical requirements.

The display device provided by an embodiment of the present disclosure includes at least one reflective dielectric layer 102, thereby increasing reflection of projected light L emitted into the display device, reducing loss of the projected light L in the display device, and improving projection effect of projected light L on the display device.

In the above embodiments, the focus of each embodiment is different, and for a part that is not detailed in an embodiment, reference may be made to related descriptions of other embodiments.

The display device has been described in detail with embodiments provided by the present disclosure which illustrates principles and implementations thereof. However, the description of the above embodiments is only for helping to understand the technical solution of the present disclosure and core ideas thereof, and it is understood by those skilled in the art that many changes and modifications to the described embodiment can be carried out without departing from the scope and the spirit of the disclosure that is intended to be limited only by the appended claims.

1. A display device, comprising a liquid crystal cell and at least one reflective dielectric layer;
wherein the at least one reflective dielectric layer is configured to increase reflection of projected light emitted into the display device, and the projected light is emitted from a projection pointer, and the at least one reflective dielectric layer is disposed in the liquid crystal cell.

2. The display device of claim 1, wherein the display device includes two polarizers respectively attached to two opposite sides of the liquid crystal cell, and the at least one reflective dielectric layer is disposed between at least one of the two polarizers and the liquid crystal cell.

3. The display device of claim 2, wherein each of the two polarizers comprises a first polarizer attached to a light exiting side of the liquid crystal cell, and the at least one reflective dielectric layer is disposed between the first polarizer and the light exiting side of the liquid crystal cell.

4. (canceled)

5. The display device of claim 1, wherein the liquid crystal cell comprises a color filter substrate, the color filter substrate comprises a first substrate, a first conductive electrode, and a first alignment layer, a first polarizer is attached to a side of the first substrate, the first conductive electrode is disposed on a side of the first substrate away from the first polarizer, the first alignment layer is disposed on a side of the first conductive electrode away from the first conductive electrode, and the at least one reflective dielectric layer is disposed between the first substrate and the first conductive electrode; or
the at least one reflective dielectric layer is disposed between the first conductive electrode and the first alignment layer.

6. The display device of claim 5, wherein the at least one reflective dielectric layer is disposed between the first substrate and the first conductive electrode, and a refractivity of the at least one reflective dielectric layer is greater than a refractivity of the first substrate and a refractivity of the first conductive electrode.

7. The display device of claim 6, wherein a difference between the refractivity of the at least one reflective dielectric layer and the refractivity of the first substrate is greater than or equal to 0.4.

8. The display device of claim 6, wherein the refractivity of the at least one reflective dielectric layer is greater than 2.2.

9. The display device of claim 5, wherein the first conductive electrode is a common electrode of the display device.

10. The display device of claim 9, wherein the first conductive electrode is an indium tin oxide transparent electrode or an indium zinc oxide transparent electrode.

11. The display device of claim 4, wherein the liquid crystal cell comprises an array substrate, the array substrate comprises a second substrate, a second conductive electrode, and a second alignment layer, a second polarizer is attached to a side of the second substrate, the second conductive electrode is disposed on a side of the second substrate away from the second polarizer, the second alignment layer is disposed on a side of the second conductive layer away from the second substrate, and the at least one reflective dielectric layer is disposed between the second substrate and the second conductive electrode; and/or
the at least one reflective dielectric layer is disposed between the second conductive electrode and the second alignment layer.

12. The display device of claim 11, wherein the second polarizer is attached to a light exiting side of the liquid crystal cell, and the second conductive layer is a patterned metal layer.

13. The display device of claim 12, wherein the patterned metal layer comprises a first patterned metal layer and a second patterned metal layer, the first metal layer is configured to form a gate and scan lines of a thin film transistor (TFT), and the second metal layer is configured to form a source/drain layer and data lines of the TFT.

14. The display device of claim 11, wherein the second conductive electrode is a pixel electrode of the display device.

15. The display device of claim 2, wherein the polarizer comprises a first polarizer attached to a light exiting side of the liquid crystal cell, a photoexcitation layer is disposed on a surface of the first polarizer, and the photoexcitation layer is excited by light having a first wavelength and emits light having a second wavelength.

16. The display device of claim 15, wherein a material of the photoexcitation layer is selected from the group consisting of a fluorescent material, a photoluminescent material, and an up-conversion material.

17. The display device of claim 1, wherein the at least one reflective dielectric layer comprises a first reflective dielectric layer and a second reflective dielectric layer which are disposed alternately, the first reflective dielectric layer is disposed near a light exiting side of the display device, and a refractivity of the first reflective dielectric layer is greater than a refractivity of the second reflective dielectric layer.

18. The display device of claim 17, wherein the refractivity of the first reflective dielectric layer is greater than or equal to 1.8, the refractivity of the second reflective dielectric layer is greater than 1 and less than or equal to 1.6, and a difference between the refractivity of the first reflective dielectric layer and the refractivity of the second reflective dielectric layer is greater than or equal to 0.4.

19. The display device of claim 18, wherein the refractivity of the first reflective dielectric layer is equal to 2, and the refractivity of the second reflective dielectric layer is equal to 1.6.

20. The display device of claim 17, wherein thicknesses of the first reflective dielectric layer and the second reflective dielectric layer range from 40 nm to 60 nm.

21. The display device of claim 1, wherein the liquid crystal cell comprises a color filter substrate, the color filter substrate comprises a first substrate, a first conductive electrode, and a first alignment layer, a first polarizer is attached to a side of the first substrate, the first conductive electrode is disposed on a side of the first substrate away from the first polarizer, the first alignment layer is disposed on a side of the first conductive electrode away from the first conductive electrode, and the at least one reflective dielectric layer is disposed between the first substrate and the first conductive electrode; and
the at least one reflective dielectric layer is disposed between the first conductive electrode and the first alignment layer.
